(19) United States
(12) Patent Application Publication
(10) Pub. No.: US 2020/0045933 A1
(43) Pub. Date: Feb. 13, 2020

(54) BAIT STATION SYSTEM

(71) Applicant: The United States of America, as represented by the Secretary of Agriculture, Washington, DC (US)

(72) Inventors: Grace F. Hummell, Silver Spring, MD (US); Erika T. Machtinger, State College, PA (US); Andrew Y. Li, Ellicott City, MD (US)

(21) Appl. No.: 16/534,233

(22) Filed: Aug. 7, 2019

Related U.S. Application Data
(60) Provisional application No. 62/715,494, filed on Aug. 7, 2018.

(51) Int. Cl. A01K 13/00

(52) U.S. Cl. CPC A01K 13/003

(57) ABSTRACT

A novel bait station system attracts animals and applies an acaricide, pesticide, and/or insecticide onto the animal when the animal attempts to feed on an attractant, or when the animal feeds on the attractant. The bait station system contains an attractant bin, at least one horizontal applicator for applying the acaricide, pesticide, and/or insecticide to the animal, and at least one vertical pole-type support which positions the horizontal applicator in the proper position. Each vertical pole-type support is attached to a flexible joint which permits the vertical pole-type support and the attached horizontal applicator to displace when an animal pushes against either the vertical pole-type support and horizontal applicator and then returns the vertical pole-type support and the attached horizontal applicator back to the intended position after the animal stops displacing them. Each flexible joint is attached to the attractant bin or to elevating anchors which are attached to the attractant bin.

### REFERENCE TO RELATED APPLICATIONS

This application claims the benefit of U.S. Provisional Application No. 62/715,494, filed Aug. 7, 2018, which is incorporated herein by reference in its entirety.

### BACKGROUND OF THE INVENTION

### Field of the Invention

This invention relates to a bait station system for applying acaricide, pesticide, and/or insecticide onto various sized animals while the animals feed on a mineral block or salt block. The acaricide, pesticide, and/or insecticide kills parasites, pests (including ticks and other arthropods), and/or insects on or in the targeted animals.

### Description of Related Art

Ticks are obligate blood sucking ectoparasites of vertebrates particularly mammals and birds. Tick bites cause mechanical damage, irritation, inflammation and hypersensitivity. Infestation with a large number of ticks may cause anemia and reduced productivity. Salivary secretions of some ticks cause toxicosis and paralysis. Hard ticks may affect human and animal health by transmission of numerous tick-borne pathogens.

The tick-borne diseases can be caused by viruses, bacteria, or parasites. Most people and animals become infected through tick bites during the spring and summer months. Tick-borne diseases are becoming a serious problem. Lyme disease and human anaplasmosis have emerged as two of the most common vector born bacterial illnesses in the United States. Borrelia burgdorferi, B. hermsii, B. turicatae, B. parkeri, Ehrlichia canis, E. chaffeensis, Anaplasma phagocytophilium, A. platys, Rickettsia rickettsii, Babesia canis vogeli, B. gibsoni, and B. conradae are just some of the various pathogens for which ticks are vectors.

U.S. Pat. No. 5,050,539 (Liegner, issued Sep. 24, 1991) is an example of a device that sprays acaricide on deer and other animals when the animal steps on a platform thus triggering the spraying of the pesticide onto the animal and the killing of ticks that feed on the animal. One problem with this prior art device is that the acaricide is not always effectively applied directly to the animal. Overspray of the acaricide may result in contamination of the surrounding environment which can be a hazard to humans and other animals if too much acaricide accumulates on the ground and plants near this device. Additionally, most of the prior art devices are not sufficiently sensitive to spray small animals, such as raccoons, rodents, squirrels, etc., that may feed on a salt block or mineral block, thus missing a potential population of ticks and other parasites.

U.S. Pat. No. 5,367,983 (Pound et al., issued Nov. 29, 1994) provides another example of a device at which deer feed and a pesticide is applied to the animal during feeding. This device has a reservoir containing the pesticide, conduits, a pressure activated flow control valve, a pump and pressure sensitive controller. The components are used to apply the pesticide onto the inside of a vertical applicator. The pesticide diffuses from the inside of the vertical applicator to the outside of the vertical applicator and is applied to the deer and other large animals when the deer and other large animals rub against the vertical applicator while feeding on the corn that is at the bottom of the device. This device has problems with maintaining (i) the appropriate amount of pesticide on the vertical applicator, (ii) the active spray device, and (iii) other associated components. Another problem with the device is that the deer and other large animal rub against the vertical applicator and move the vertical applicator out of position. When out of position, the vertical applicator fails to apply the pesticide onto the animal when it feeds. Another problem with this device is its size and weight and need to refill the device with feed on a weekly basis. The feed, corn, is also problematic because it is harmful to the deer and other large animals. Animals fail to obtain sufficient essential nutrients from corn. Large quantity of grain, or the sudden ingestion of feed high in carbohydrates without acclimation results in acidic conditions in a deer's rumen (stomach). The acid kills bacteria necessary for digestion thereby causing bloating, diarrhea, enteritis, and in extreme cases death (Wobeser and Runge, J. Wildlife Management, 39(3):596-600 1975; Woolf and Kradel, J. Wildlife Diseases, 13(3):281-285 1977; and Michigan Department of Natural Resources 2004. This condition reportedly occurs yearly in Michigan. During a severe winter in Saskatchewan 30% of the deer found dead near cattle feedlots were diagnosed with lactic acidosis (Wobster and Runge, 1975). Corn bait can also be incompatible with the physiological state of animals if the corn is contaminated with a toxin. Spoiled and moldy feed may contain aflatoxins which are immunosuppressive, hepatotoxic, and carcinogenic. Aflatoxins can cause disease or death in wildlife (O'Hara, T. M., Mycotoxins pp. 24-30 in Fairbrother, et al., eds. Noninfectious diseases of wildlife. Iowa State University Press, Ames, Iowa 1996; and Quist, et al., J. Wildlife Diseases 36(3):436-444 2000). Fischer, et al., J. Wildlife Diseases 31(4):570-572 (1995) found that approximately 50% of the corn samples collected from deer bait piles had up to 750 ppb aflatoxin, well over animal feed limits. Aflatoxin concentrations increase over time during storage and in wildlife feeders (Thompson and Henke, J. Wildlife Diseases 36(1):172-179 2000; and Oberhau and Dabbert, J. Wildlife Diseases 37(3):475-480 2001). The device used corn as an attractant. The corn quickly became infected with mold and/or other fungi after rain or high humidity, thus creating a health hazard for wildlife, not just deer. The device also fails to apply pesticide onto small animals.

U.S. Pat. No. 8,056,513 (Abel et al., issued Nov. 15, 2011) describes an improvement over the device disclosed in U.S. Pat. No. 5,367,983. The device described in U.S. Pat. No. 8,056,513 has springs (straight extension springs) internal to the vertical applicators. The lower part of the extension spring is attached to the base of the device and the upper part of the extension spring is attached to the top of the vertical applicator. These straight extension springs supposedly permit the animal to move the vertical applicator out of alignment and then, when the animal moves away, the tension of the extension spring moves the vertical applicator back into its original position for continued use. In principle, this extension spring should work as anticipated. But, outside of a laboratory setting, the extension spring eventually deforms and is frequently unable to move the vertical applicator back to the applicator's original position. Either the extension spring breaks, or the applicator or extension spring gets stuck on another part of the device. In addition, this device still is extremely large and extremely heavy. It uses corn to attract the animals, which as discussed above, harms the animals. The vertical applicators of this device fail to apply acaricide onto small animals such as squirrels, opossums, woodchucks, raccoons, crows, various song birds, and turkeys which feed on the corn. These animals can harbor ticks.

A need exists for a bait station system that applies acaricide, pesticide, and/or insecticide onto large and small animals. This bait station system uses an attractant that is not harmful to the mammals nor to the environment to attract the mammals to the bait station system. The acaricide, pesticide, and/or insecticide is applied onto the mammal when the mammal attempts to feed on the attractant.

### BRIEF SUMMARY OF THE INVENTION

It is an object of this invention to have a bait station system which attracts animals and applies an acaricide, pesticide, and/or insecticide onto the animal when the animal attempts to feed on an attractant, or when the animal feeds on the attractant.

It is a further object of this invention that the bait station system contains an attractant bin for holding an attractant, at least one horizontal applicator for applying the acaricide, pesticide, and/or insecticide to the animal, and at least one vertical pole-type support which positions the horizontal applicator in the proper position. It is another object of this invention that each vertical pole-type support is attached to a flexible joint which permits the vertical pole-type support and the attached horizontal applicator to displace when an animal pushes against either the vertical pole-type support and/or horizontal applicator and then returns the vertical pole-type support and the attached horizontal applicator back to the original position after the animal stops displacing them. It is a further object of the invention that the bait station system contains an attractant which can be a mineral block or a salt block with or without various medicines, vaccines, etc., added for oral delivery.

It is another object of this invention that the bait station system contains at least one elevating anchor which is attached to the side or bottom of the attractant bin and lifts the attractant bin off the ground. The flexible joints can be attached to the elevating anchors. It is another object of the invention that the attractant bin contains one or more interior walls that keep the attractant located under the housing cover, with at least one interior wall having an attractant opening so that an animal has access to the attractant. Another object of the invention is that the attractant bin has a housing cover that protects the attractant from rain or snow.

It is a further object of this invention that the attractant bin can have one or more secondary openings through which small mammals and/or small birds can travel through and have access to the attractant. The secondary openings can be located on the side of the attractant bin. It is a further object of this invention that the attractant bin contains one or more small tunnels which can contain a material (fiber, paper, etc.) that contains an acaricide, pesticide and/or insecticide. A small mammal or small bird may enter the tunnel and have the acaricide, pesticide and/or insecticide applied to the animal and/or the animal may take the material containing the acaricide, pesticide and/or insecticide back to its burrow, nest, or other type of home.

It is an object of this invention to have a method for applying an acaricide, pesticide and/or insecticide to an animal by applying the acaricide, pesticide and/or insecticide onto each horizontal applicator of the bait station system, placing the bait station system in an area where animals (mammals and birds) live, and placing an attractant into the bait station system such that when the animal accesses (or attempts to access) the attractant, the animal rubs against one or more horizontal applicators and the acaricide, pesticide and/or insecticide is applied to the animal. It is another object that the attractant can be a salt block, mineral block or feed with or without orally deliverable medication or vaccine. The acaricide, pesticide and/or insecticide can be permethrin, fenvalerate, cypermethrin, flucythrinate, fluvalinate, flumethrin, cyfluthrin, cyhalothrin, deltamethrin, abamectin, doramectin, eprinomectin, ivermectin, selamectin, milbemectin, milbemycin, moxidectin, amitraz, lindane, methoxychlor, chloropyrifos, coumaphos, crotoxyphos, cydectin, diazinon, dichlorvos, dioxathion, famphur, fenthion, naled, malathion, phosmet, ronnel, tetrachlorvonphos, pirimophos methyl, carbaryl, bendiocarb, propoxur, chlordimeform, a mixture of piperonyl butoxide and permethrin or pyrethroid pesticides, and a combination thereof. Other types of medication can be birth control compounds.

It is an object of this invention to have a method for killing insects, ticks, and other pests that live on or in an animal (mammal or bird) by applying an acaricide, pesticide and/or insecticide onto each horizontal applicator of the bait station system, placing an attractant into the bait station system, and placing the bait station system in an area where animals (mammals and birds) live, such that when the animal accesses (or attempts to access) the attractant, the animal rubs against one or more horizontal applicators and the acaricide, pesticide and/or insecticide is applied to the animal and kills the insects, ticks, and other pests living on or in the animal. It is another object that the attractant can be a salt block, mineral block or feed with or without orally deliverable medication or vaccine. The acaricide, pesticide and/or insecticide can be permethrin, fenvalerate, cypermethrin, flucythrinate, fluvalinate, flumethrin, cyfluthrin, cyhalothrin, deltamethrin, abamectin, doramectin, eprinomectin, ivermectin, selamectin, milbemectin, milbemycin, moxidectin, amitraz, lindane, methoxychlor, chloropyrifos, coumaphos, crotoxyphos, cydectin, diazinon, dichlorvos, dioxathion, famphur, fenthion, naled, malathion, phosmet, ronnel, tetrachlorvonphos, pirimophos methyl, carbaryl, bendiocarb, propoxur, chlordimeform, a mixture of piperonyl butoxide and permethrin or pyrethroid pesticides, and a combination thereof. Other types of medication can be birth control compounds.

### BRIEF DESCRIPTION OF THE SEVERAL VIEWS OF THE DRAWINGS

FIG. 1 is an elevational perspective view of the bait station system, including section lines II and III.

FIG. 2 is a cross-sectional front (longitudinal) view bisecting the bait station system along the line II in FIG. 1.

FIG. 3 is a cross-sectional view of the bait station system along the line III in FIG. 1.

FIG. 4 is an end view of the bait station system, including the attractant opening 112.

FIG. 5 is a cross-sectional view of non-spring type of flexible joint 124 and vertical pole-type support 120 securely connected to each other with a bolt 126.

FIG. 6 is a partial cross-sectional view of an alternative embodiment of a flexible joint using a tapered conical spring 128 with an integrated vertical protruding member 132 (both shown as solid, unitary pieces) and vertical pole-type support 120 (shown as a cross-sectional piece) securely connected to each other with glue (not shown).

### DETAILED DESCRIPTION OF THE INVENTION

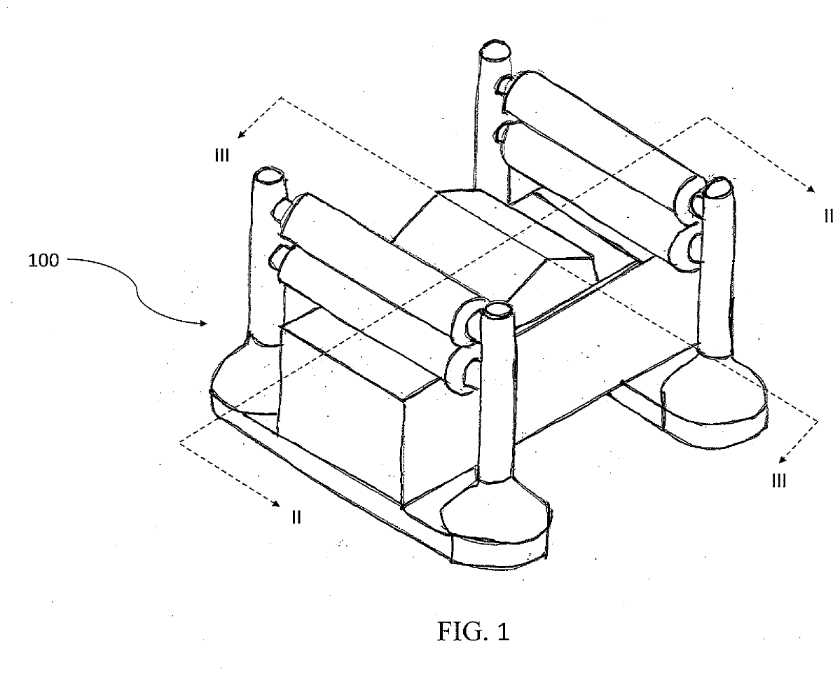

As generally shown in FIG. 1, the method and system described herein involves a bait station system that applies acaricide, pesticide, and/or insecticide onto large and small animals. For large animals, the acaricide, pesticide, and/or insecticide is applied to the head or neck of the animal when it attempts to access or actually accesses the attractant inside the bait station system. For small animals, the acaricide, pesticide, and/or insecticide is applied to the legs, back, side, abdomen, head or other body part as the animals tries to reach the attractant inside the bait station system or as the animal leaves the bait station system. The bait station system is generally an improvement of the system disclosed in U.S. Pat. No. 8,056,513, which is incorporated in its entirety by reference. The improvements include, but are not limited to, one or more horizontal applicators that apply an acaricide, pesticide, and/or insecticide to the animal when the animal contacts the one or more horizontal applicators and one or more flexible joints that connect the vertical pole-type supports to the attractant bin. The flexible joint (i) deforms and bends when an animal presses with sufficient force against the one or more horizontal applicators and/or one or more vertical pole-type supports connected to the flexible joint and (ii) return to its original shape and position when the force is removed thereby returning the one or more horizontal applicators and/or one or more vertical pole-type supports connected to the flexible joint to their original positions. These improvements and other improvements are discussed in more detail infra.

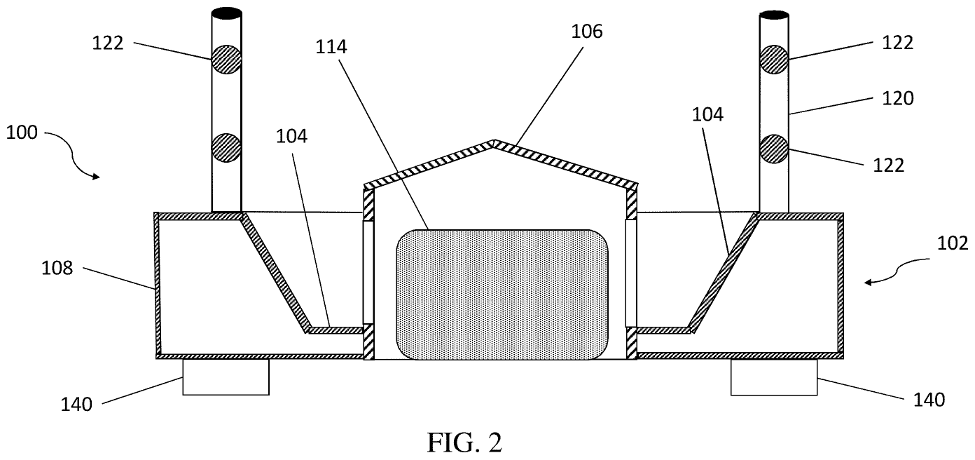

As shown in general in FIG. 1 and more specifically in FIGS. 2, 3 and 4, the bait station system 100, contains a generally rectangular enclosure referred to as an “attractant bin” 102. An attractant 114 is placed in the center of the attractant bin 102. Non-limiting examples of the attractant are a salt block, mineral block, feed, or another type of attractant that draws the animals to the bait station system 100. The attractant 114 is shielded by a housing cover 106 which limits access to the attractant 114 and shelters the attractant from the weather. The floor 104 of the bait station system 100 angles upwardly which limits access to the attractant 114. In one embodiment, the floor 104 is contiguous. In another embodiment, the floor 104 is multi-level, i.e., one or more parts of the floor is higher than other parts of the floor and are not necessarily attached to each other (i.e., gaps exist in the floor). In another embodiment, the floor 104 contains one or more holes which permit(s) water to exit from the bait station system 100, and/or reduce(s) the weight of and amount of material in the bait station system 100. In another embodiment, the one or more holes can be located on the exterior wall(s) 108 of the attractant bin 102, near to the floor 104. The housing cover 106 is detachably connected to the bait station system 100. The housing cover 106 can be flat or pitched.

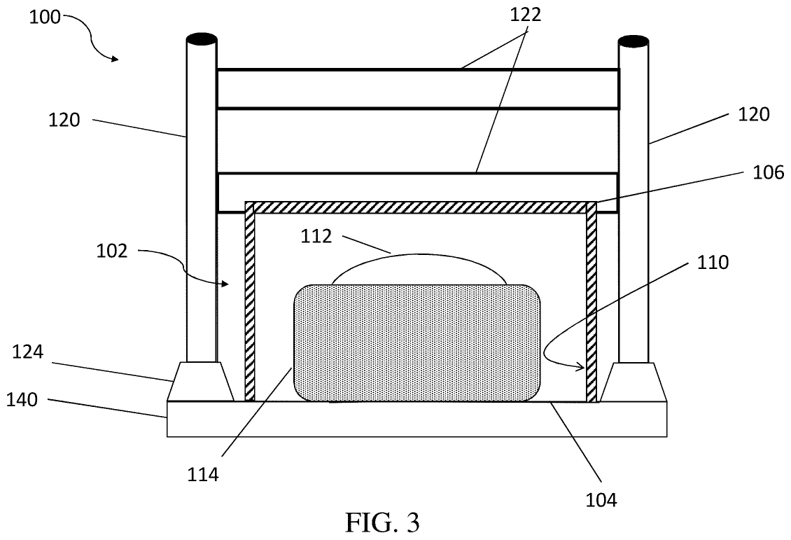

As generally shown in FIGS. 1 and 2, at each end of the bait station system 100 is a pair of vertical pole-type supports 120 that support one or more horizontal applicators 122. Each vertical pole-type support 120 is securely attached to a flexible joint 124 (best shown in FIGS. 3-6) that enables the vertical pole-type supports 120 to bend, flex, and/or deform when sufficient force is applied to a horizontal applicator or a vertical pole-type support by an animal. Specifically, the flexible joint 124 is a semi-rigid material which permits the vertical pole-type support 120 to move or flex relative to the vertical without breaking. Each horizontal applicator 122 is securely connected at both ends, or securely connected at one end and detachably connected at the other end, or detachably connected at both ends, to one or more vertical pole-type supports 120. In one embodiment, an acaricide, pesticide, and/or insecticide is applied to the exterior surface of each horizontal applicator 122. In one embodiment, the exterior surface of a horizontal applicator 122 is covered with a detachable, absorbent material. In another embodiment, sections of one or more vertical pole-type supports that extend above the exterior walls 108 are covered with the detachable, absorbent material. To be clear, in this embodiment, not every section of a vertical pole-type support that is above the exterior walls needs to be covered with the detachable, absorbent material.

For the purposes of this invention, a “detachable, absorbent material” includes, but is not limited to, a cloth, a fiber, a paint roller cover, a polymer, and any other material, onto or into which the acaricide, pesticide, and/or insecticide is applied. A glue strip and similar items are detachable, absorbent materials.

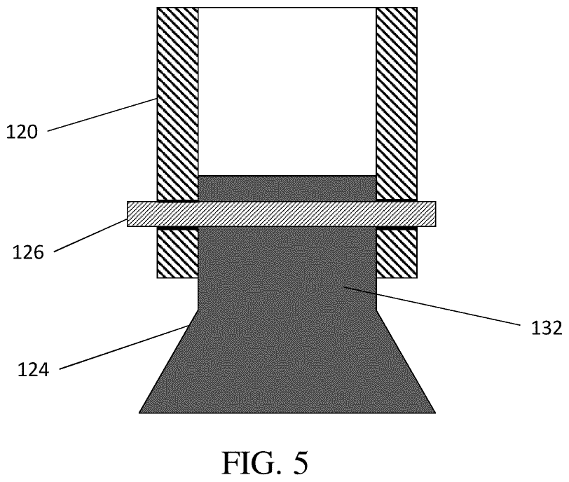

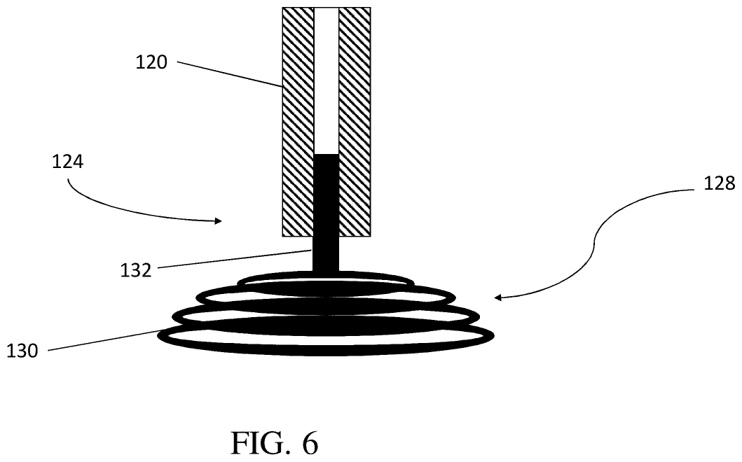

For the purposes of this disclosure, the term “flexible joint” is defined as: (1) a non-spring joint or (2) a tapered conical spring joint (see FIG. 6). The non-spring flexible joint is a semi-rigid material such as rubber, plastic, a polymer, or a composite of materials (e.g., metal/rubber composite, metal/polymer composite, rubber/polymer composite, metal/rubber/polymer composite) constructed so that the flexible joint can deform without breaking and return to its original position and conformation. An example of a flexible joint that is a non-spring joint is shown in FIG. 5. This flexible joint is generally conical and has a wide base that narrows along its height with an integrally connected vertical protruding member extending approximately above the center of the flexible joint. The vertical pole-type support 120 has a hollow interior into which the vertical protruding member 132 of the flexible joint 124 is inserted. The vertical pole-type support is securely attached to the vertical protruding member portion of the flexible joint via any secure attachment known in the art. As shown in FIG. 5, a bolt 126 transverses the vertical protruding member 132 of the flexible joint 124 and the vertical pole-type support 120 so that the flexible joint and the vertical pole-type support are securely attached to each other. Secure attachments are known in the art. Non-limiting examples of secure attachment are bolt, screw, nail, rivet, glue, welding, clamp, etc. By having the bottom of the vertical pole-type support terminate prior to the widening of the base of the flexible joint, the flexible joint can flex, deform, and return to its original shape freely without having the vertical pole-type support interfere with the movement of the flexible joint. This flexible joint can be hollow or solid (as shown in FIG. 5). In further alternative embodiments, the vertical support 120 can be positioned within the protruding member portion 132 of the flexible joint 124.

As shown in FIG. 6, the flexible joint 124 can be a tapered conical spring joint which contains a tapered conical spring 128 with a wide base 130 that narrows along its height and has an integrally connected vertical protruding member 132 extending approximately above the center of the flexible joint. This vertical protruding member can be a solid (as shown in FIG. 6) or hollow rod made from metal, polymer, composite, etc., or tightly coiled spring. A “tapered conical spring” is a cone shaped compression spring that has a tapered body with a large outer diameter at the base and a small outer diameter at the top. Thus, a tapered conical spring 128 provides enhanced stability under conditions that would cause a straight compression spring to buckle or bend. The tapered conical spring 128 can be made from metal, polymer, composite, etc. The vertical pole-type support 120 has a hollow interior into which the vertical protruding member 132 of the flexible joint 124 is inserted. In FIG. 6, the vertical pole-type support 120 is securely attached to the flexible joint with glue (not shown). Non-limiting examples of secure attachment are bolt, screw, nail, rivet, glue, welding, clamp, etc. This flexible joint can deform and flex when an animal presses against one or more horizontal applicators and/or one or more vertical pole-type supports. As pressure is released from the one or more horizontal applicators and/or one or more vertical pole-type supports, the flexible joint returns to its preferred shape without having the attached vertical pole-type support interfering with the movement of the tapered conical spring. This type of flexible joint and its attachment to the vertical pole-type support is an improvement over the prior art straight spring. The prior art straight spring and the attached vertical support often became stuck at an angle from their original position when animal pushed against the vertical support and deformed or bent the straight spring. Alternatively, the vertical support or straight spring became stuck on another part of the prior art device.

The flexible joint can be deformed when an animal attempts to access the attractant and while an animal feeds on the attractant, because the animal pushes against one or more vertical pole-type supports and/or one or more horizontal applicators. This flexible joint permits an animal to deflect the one or more vertical pole-type supports and/or one or more horizontal applicators without otherwise damaging the bait station system.

In another embodiment, the one or more vertical pole-type supports 120 and the one or more horizontal applicators 122 are located on one side of the bait station system 100, but not the other side. In this embodiment, an animal's primary access to the attractant 114 is on the side of the bait station system 100 containing the one or more vertical pole-type supports 120 and the one or more horizontal applicators 122.

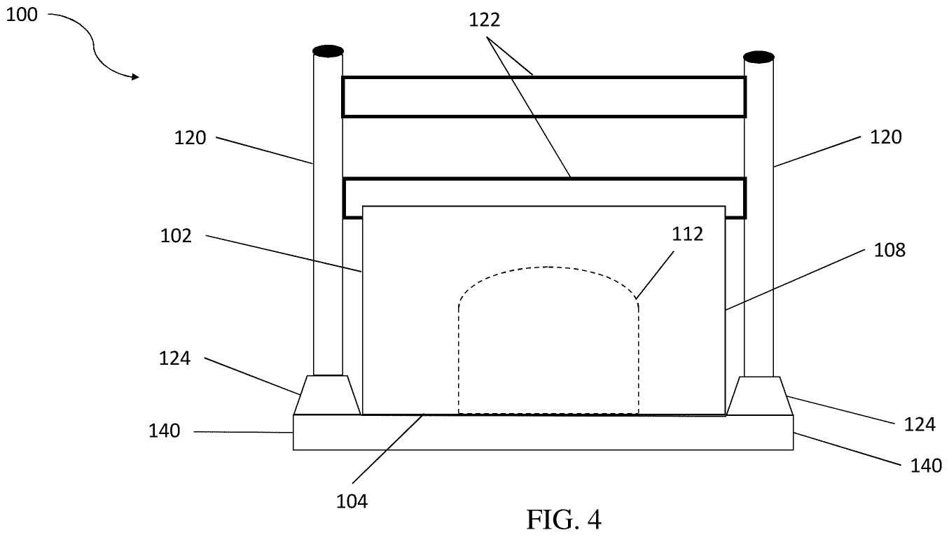

As shown in FIGS. 3 and 4, the horizontal applicators 122 can be covered with a material that is soaked in an acaricide, pesticide, and/or insecticide or onto which the acaricide, pesticide, and/or insecticide is/are applied. When a large animal attempts to access the attractant 114, the large animal's head or neck contacts the one or more horizontal applicators 122, and the acaricide, pesticide, and/or insecticide is applied to the large animal's neck or head. In addition, as a large animal feeds on the attractant 114, the animal contacts one or more horizontal applicators 122, and the acaricide, pesticide, and/or insecticide is again applied to the large animal. When a small animal climbs over the outer ends of the exterior walls 108 to access the attractant 114, various parts of the small animal contacts one or more horizontal applicators 122, and the acaricide, pesticide, and/or insecticide is applied to those parts of the small animal.

As shown in FIG. 2, in one embodiment, an upwardly angled floor 104 of the bait station system 100 keeps the attractant 114 in the center of the bait station system 100 and forces animals to contact the one or more horizontal applicators 122.

As seen in FIG. 3, in another embodiment, the attractant bin 102 contains a pair of interior walls 110, with one interior wall on each side of the attractant 114. One or both interior walls 110 have an attractant opening 112 that selectively permits an animal's access to the attractant 114 and forces an animal to contact the one or more horizontal applicators 122 while feeding on the attractant 114. In this embodiment, the interior walls 110 keep the attractant 114 in the center of the bait station system 100. Each attractant opening 112 can vary in size and shape but is of sufficient size for a large animal's mouth to access the attractant 114. Non-limiting examples of the shape of the attractant opening include an arch, circle, ellipse, triangle, rectangle, square, trapezoid, pentagon, etc. FIG. 4, an end view of the bait station system, shows the location of an attractant opening 112 on the inside of the attractant bin 102.

As shown in FIGS. 2, 3, and 4, the attractant bin 102 rests on two or more elevating anchors 140 that elevate the attractant bin 102 off the ground and permit water to exit the attractant bin via the holes in the attractant bin. The elevating anchors also provide enhanced stability to the bait station system 100. In one embodiment, an elevating anchor 140 extends beyond both exterior walls 108 and underneath the attractant bin 102. See FIGS. 2, 3, and 4. In another embodiment, an elevating anchor 140 extends beyond one exterior wall 108 of the attractant bin 102, and underneath the attractant bin 102. In this embodiment, four or more elevating anchors can be used to stabilize the bait station system. In another embodiment, an elevating anchor 140 is attached to an exterior wall 108 of the attractant bin 102, and does not extend underneath the attractant bin 102. In a fourth embodiment, the entire elevating anchor is beneath the attractant bin 102, but does not extend beyond the exterior wall of the attractant bin. The elevating anchor can be made from any material, such as but not limited to, wood, concrete, rubber, plastic or other polymer, metal, and the like.

In one embodiment, the elevating anchors 140 can be detachable secured to the attractant bin 120 via screws, bolts, pins, clamps, and the like. In another embodiment, the elevating anchors 120 can be permanently secured to the attractant bin 120 via glue, welding, and the like. In another embodiment, if the attractant bin is made from a polymer or similar substance, the elevating anchors can be integrated into the attractant bin during the production of the attractant bin if one is using extrusion of the polymer into a mold; in which case the elevating anchors are permanently secured to the attractant bin.

When the elevating anchors are detachably secured to the bottom of the attractant bin, one can connect each elevating anchor to the attractant bin at independent and different distances from the mid-point of the attractant bin. Thus, each elevating anchor 140 is movable along the bottom of the attractant bin and/or along the exterior wall 108 of the attractant bin 102. When an elevating anchor extends beyond the outer edge of the attractant bin, one can pass a stake, rod, anchor, or other similar item through the elevating anchor into the ground to assist in keeping the bait station system stationary and up-right.

As shown in FIGS. 2, 3, and 4, the vertical pole-type supports 120 are securely attached to the flexible joints 124 which are securely attached to the elevating anchors 140. In another embodiment, the vertical pole-type supports 120 are securely attached to the flexible joints 124 which are securely attached to the exterior walls 108. In another embodiment, the vertical pole-type supports 120 are securely attached to the flexible joints 124 which are securely attached to the floor 104 of the attractant bin 102. The flexible joints can be securely attached to the elevating anchors using any known in the art means. Non-limiting examples are bolts, screws, nails, rivets, glue, welding, clamps, etc.

In one embodiment, the width of the attractant bin 102 can range from approximately 8 inches to 30 inches, the height of the attractant bin 102 can range from approximately 5 inches to approximately 30 inches and its length can range from approximately 20 inches to approximately 50 inches. The distance from the ground to the top of the vertical pole-type supports 120 can vary, depending on the height of the attractant bin 102. In one embodiment, the distance ranges from approximately 6 inches to approximately 50 inches. In one embodiment, depending on the width of the attractant bin 102, the one or more horizontal applicators 122 can range in length from approximately 9 inches to approximately 35 inches. In one embodiment, the distance from the ground to the top of the housing cover 106 can also vary, depending on the height of the attractant bin 102 and the size of the attractant 114 that is to be placed under the housing cover 106. So, in one embodiment, the distance from the ground to the top of the housing cover 106 can range from approximately 5 inches to approximately 50 inches. In other embodiments, the bait station system can be larger or smaller than these measurements.

In another embodiment, the width of the attractant bin 102 is between approximately 10 inches and approximately 20 inches; its length is between approximately 25 inches and approximately 40 inches; and its height is between approximately 7 inches to approximately 20 inches. In yet another embodiment, the width of the attractant bin 102 is approximately 13 inches; its length is approximately 32 inches; and its height is approximately 10 inches. The measurements of the other components of this bait station system 100 can vary based on the measurements of the attractant bin 102.

In the embodiment of the bait station system 100 containing interior walls 110 that restrict access to the attractant 114, the attractant opening 112 in the interior walls are of sufficient size to permit a large animal to have limited access to the attractant. In these embodiments, the attractant opening has an arch shape and can range from approximately 5.0 inches to approximately 10.5 inches tall and from approximately 2.5 inches to approximately 7.5 inches wide. In another embodiment, the arched attractant opening can range from approximately 6.25 inches to approximately 9.25 inches tall and from approximately 3.0 inches to approximately 7 inches wide. In another embodiment, the arched attractant opening can range from approximately 6.75 inches to approximately 8.5 inches tall and from approximately 3.25 inches to approximately 6.75 inches wide.

As shown in FIGS. 1, 2, 3, and 4, two vertical pole-type supports 120 are attached to opposite ends of two horizontal applicators 122, and as shown in FIG. 1, 3, or 4, each vertical pole-support is attached to a flexible joint 124. As shown in FIGS. 1 and 2, in one embodiment, the bait station system 100 contains two of these combinations of vertical pole-type supports 120 and horizontal applicators 122. However, in another embodiment, the bait station system 100 contains one, three or more of these combinations of vertical pole-type supports 120 and horizontal applicators 122 and can be located at various positions on the attractant bin 102. In another embodiment, two vertical pole-type supports 120 are attached to one, two, three or more horizontal applicators 122.

In yet another embodiment, one vertical pole-type support 120 is attached to one, two, three, or more horizontal applicators 122. In this embodiment, the vertical pole-type support can be attached to one end of the horizontal applicator(s) or to the approximate middle of each horizontal applicator (or any location in-between). In this embodiment, the bait station system can contain one, two, three, four, or more of these single vertical pole-type supports (each vertical pole-type supports attached to one or more horizontal applicators).

The length of the horizontal applicators can vary with the width and length of the bait station system and the location of the horizontal applicators. It is useful for the horizontal applicators be of sufficient number and length and be located at different heights such that both large animals and small animals contact at least one horizontal applicator when the animal attempts to feed or actually feeds on the attractant. As described above, because the vertical pole-type support is attached to a flexible joint, when an animal pushes the vertical pole-type support and/or the horizontal applicator(s) and displaces the vertical pole-type support and the attached horizontal applicant, they return to their prior position, being in place for the next animal to contact them.

In an alternative embodiment, only one interior wall 110 contains an attractant opening 112 and the other interior wall 110 is contiguous (i.e., lacking an attractant opening). In this embodiment, the bait station system contains horizontal applicator(s) 122 on the side of the bait station system 100 which contains the interior wall 110 having an attractant opening 112. In this manner, an animal still contacts the horizontal applicator(s) 122 when the animal feeds on and/or attempts to reach the attractant. In this embodiment, the bait station system 100 still contains two more elevating anchors 140 that elevate the attractant bin 102 off the ground.

In another embodiment of this bait station system 100, the attractant bin 102 contains one or more secondary openings in one or more exterior walls 108 located such that a small animal can enter the one or more secondary openings and gain access to the attractant 114. These secondary opening differ from any holes through which water may egress the attractant bin 102 because these secondary openings contain an absorbent material to which one applies an acaricide, pesticide and/or insecticide. As the small animal traverse one or more of the secondary openings, the small animal contacts the absorbent material and the acaricide, pesticide and/or insecticide is applied to the small animal. In addition, absorbent material containing acaricide, pesticide and/or insecticide can be placed on the floor 104 of the attractant bin in line with the secondary opening so that the small animal contacts that absorbent material when the small animal exits the secondary opening.

In yet another embodiment of this bait station system 100, the attractant bin 102 contains one or more tunnels that is opened to the exterior of the attractant bin and closed at the distal end. The tunnel can be of sufficient diameter to permit a small animal to enter the tunnel. One inserts absorbent material containing an acaricide, pesticide and/or insecticide into the tunnel. The small animal can remove the absorbent material containing the acaricide, pesticide and/or insecticide from the tunnel and carry the absorbent material back to the small animal's den, nest, or other type of abode.

Non-limiting examples of acaricide, pesticide and/or insecticide that can be used with the bait station system include permethrin, fenvalerate, cypermethrin, flucythrinate, fluvalinate, flumethrin, cyfluthrin, cyhalothrin, deltamethrin, abamectin, doramectin, eprinomectin, ivermectin, selamectin, milbemectin, milbemycin, moxidectin, amitraz, lindane, methoxychlor, chloropyrifos, coumaphos, crotoxyphos, cydectin, diazinon, dichlorvos, dioxathion, famphur, fenthion, naled, malathion, phosmet, ronnel, tetrachlorvonphos, pirimophos methyl, carbaryl, bendiocarb, propoxur, chlordimeform, a mixture of piperonyl butoxide and permethrin or pyrethroid pesticides, and other similar chemicals or a combination thereof.

In another embodiment, the attractant also contains one or more acaricide, pesticide insecticide, birth control agent, vaccine, etc., which an animal ingests upon feeding on the attractant.

For the purposes of this invention, an “animal” is any bird or mammal. Non-limiting examples of large animals include bovine, horse, goat, sheep, deer, elk, moose, llama, alpaca, bear, canines, and felines. Non-limiting examples of small animals include birds (e.g., turkey, song birds, and crows), woodchucks, mouse, rat, chipmunk, raccoon, hedgehog, groundhog, mongoose, squirrel, and mink.

The acaricide, pesticide, insecticide, or a combination thereof that is applied onto the horizontal applicators can be formulated with a transdermal carrier which carries the acaricide, pesticide, insecticide, or a combination thereof through the dermis. Then the acaricide, pesticide, insecticide, or a combination thereof enters the blood stream of the animal and travels to all parts of the animal's body. In another embodiment, the acaricide, pesticide, insecticide, or a combination thereof could also be formulated with a carrier that spreads along the animal's epidermis. In all embodiments, after an animal rubs against a horizontal applicator of the bait station system, the animal is treated with the acaricide, pesticide, insecticide, or a combination thereof on the horizontal applicator which kill external pests and/or internal pests, as well as any parasitic animal that feeds on the host (e.g., ticks, lice, mites, fleas, biting flies, worms (living in intestines or other parts of the body), etc.).

### Experimental Data

Between Jun. 1, 2017 and Jun. 9, 2017, Table 1 shows the types of animals that accessed the bait station system, the number of times each type of animal accessed the bait station system, and the attractant used.

TABLE 1

| Species | Bait Type | Total Times used |
|---|---|---|
| White-Tail Deer | Salt | 63 |
| Squirrel | Salt | 16 |
| Raccoon | Salt | 3 |

The accompanying drawings are included herein only to further illustrate the invention and are not intended to limit the scope of the invention as defined by the claims. The above description and drawings describe at least one, but not all embodiments, of the inventions claimed. Indeed, these inventions may be embodied in many different forms and should not be construed as limited to the embodiments set forth herein; rather, these embodiments are provided so that this disclosure will satisfy applicable legal requirements.

The terms “approximately” and “about” refer to a quantity, level, value or amount that varies by as much as 30% in one embodiment, or in another embodiment by as much as 20%, and in a third embodiment by as much as 10% to a reference quantity, level, value or amount. As used herein, the singular form “a”, “an”, and “the” include plural references unless the context clearly dictates otherwise. For example, the term “a bacterium” includes both a single bacterium and a plurality of bacteria.

The foregoing detailed description and certain representative embodiments and details of the invention have been presented for purposes of illustration and description of the invention. It is not intended to be exhaustive or to limit the invention to the precise forms disclosed. It will be apparent to practitioners skilled in the art that modifications and variations may be made therein without departing from the scope of the invention. All references cited herein are incorporated by reference.

We, the inventors, claim as follows:

1. A bait station system comprising:
an attractant for attracting mammals;
an attractant bin for holding the attractant;
at least one horizontal applicator;
at least one vertical pole-type support that holds said horizontal applicator in position;
and,
a flexible joint attaching said vertical pole-type support to said attractant bin;
wherein, when an animal contacts said horizontal applicator, an acaricide, pesticide, insecticide, or a combination thereof on said horizontal applicator is applied to said animal.

2. The bait station system of claim 1, further comprising at least one elevating anchor, wherein said elevating anchor is attached to said attractant bin and wherein said flexible joint is attached to said elevating anchor.

3. The bait station system of claim 1, further comprising at least one interior wall in said attractant bin, wherein said at least one interior wall further comprises an attractant opening through which said animal accesses said attractant.

4. The bait station system of claim 1, further comprising a detachable, absorbent material on said horizontal applicator.

5. The bait station system of claim 1, wherein said attractant is a mineral block or a salt block.

6. The bait station system of claim 1, further comprising a housing cover to shelter said attractant.

7. The bait station system of claim 1, further comprising one or more secondary openings.

8. The bait station system of claim 1, further comprising one or more tunnels.

9. The bait station system of claim 8, wherein said one or more tunnels contain material containing an acaricide, pesticide, insecticide, or a combination thereof.

10. A method of applying an acaricide, pesticide, insecticide, or a combination thereof on an animal, said method comprising
(i) applying said acaricide, pesticide, insecticide, or a combination thereof to each horizontal applicator of said bait station system of claim 1;
(ii) placing said bait station system in an area where said animal lives; and
(iii) placing an attractant in said bait station system; wherein when said animal accesses said bait station system, said acaricide, pesticide, insecticide, or a combination thereof is applied to said animal.

11. The method of claim 10, wherein said attractant is a salt block, mineral block, or feed.

12. The method of claim 10, wherein said acaricide, pesticide, and insecticide are selected from the group consisting of permethrin, fenvalerate, cypermethrin, flucythrinate, fluvalinate, flumethrin, cyfluthrin, cyhalothrin, deltamethrin, abamectin, doramectin, eprinomectin, ivermectin, selamectin, milbemectin, milbemycin, moxidectin, amitraz, lindane, methoxychlor, chloropyrifos, coumaphos, crotoxyphos, cydectin, diazinon, dichlorvos, dioxathion, famphur, fenthion, naled, malathion, phosmet, ronnel, tetrachlorvonphos, pirimophos methyl, carbaryl, bendiocarb, propoxur, chlordimeform, a mixture of piperonyl butoxide and permethrin or pyrethroid pesticides, and a combination thereof.

13. A method of killing insects, ticks, and other pests that live on or in an animal, said method comprising
(i) applying an acaricide, pesticide, insecticide, or a combination thereof to each horizontal applicator of said bait station system of claim 1;
(ii) placing an attractant in said bait station system; and
(iii) placing said bait station system in an area where said animal lives; wherein when said animal accesses said bait station system, said acaricide, pesticide, insecticide, or a combination thereof is applied to said animal and said acaricide, pesticide, insecticide, or a combination thereof kills said insects, ticks, and other pests that live on or in said animal.

14. The method of claim 13, wherein said attractant is a salt block, mineral block, or feed.

15. The method of claim 13, wherein said acaricide, pesticide, and insecticide are selected from the group consisting of permethrin, fenvalerate, cypermethrin, flucythrinate, fluvalinate, flumethrin, cyfluthrin, cyhalothrin, deltamethrin, abamectin, doramectin, eprinomectin, ivermectin, selamectin, milbemectin, milbemycin, moxidectin, amitraz, lindane, methoxychlor, chloropyrifos, coumaphos, crotoxyphos, cydectin, diazinon, dichlorvos, dioxathion, famphur, fenthion, naled, malathion, phosmet, ronnel, tetrachlorvonphos, pirimophos methyl, carbaryl, bendiocarb, propoxur, chlordimeform, a mixture of piperonyl butoxide and permethrin or pyrethroid pesticides, and a combination thereof.
